(19) United States
(12) Patent Application Publication
(10) Pub. No.: US 2017/0168660 A1
(43) Pub. Date: Jun. 15, 2017

(54) Voice bullet screen generation method and electronic device

(71) Applicants: Le Holdings (Beijing) Co., Ltd., Beijing (CN); Le Shi Internet Information & Technology Corp., Beijing, Beijing (CN)

(72) Inventor: Huqiang Li, Chao Yang District (CN)

(21) Appl. No.: 15/240,152

(22) Filed: Aug. 18, 2016

Related U.S. Application Data
(63) Continuation of application No. PCT/CN2016/089574, filed on Jul. 10, 2016.

(30) Foreign Application Priority Data
Dec. 15, 2015 (CN) 201510932226.X

(51) Int. Cl. G06F 3/0481; G10L 15/26; G10L 13/08

(52) U.S. Cl. CPC G06F 3/0481; G10L 13/08; G10L 15/26; H04N 21/4788

(57) ABSTRACT

This disclosure relates to video optimization and disclose a voice bullet screen generation method and an electronic device. The generation method includes: collecting a voice-form user comment or a character-form user comment; generating the character-form user comment according to the collected voice-form user comment or generating the voice-form user comment according to the collected character-form user comment; establishing a link between the character-form user comment and the voice-form user comment; and displaying the character-form user comment containing the link of the voice-form user comment to a user in a bullet screen form. Some embodiments of this disclosure can make a user optionally listen to a bullet screen voice, providing more selections and better viewing experience to the user.

### CROSS-REFERENCE TO RELATED APPLICATIONS

The present disclosure is a continuation of PCT application No. PCT/CN2016/089574 submitted on Jul. 10, 2016. The present disclosure claims priority to Chinese Patent Application No. 201510932226.X, filed with the Chinese Patent Office on Dec. 15, 2015 and entitled “VOICE BULLET SCREEN GENERATION METHOD AND VOICE BULLET SCREEN GENERATION APPARATUS”, which is incorporated herein by reference in its entirety.

### TECHNICAL FIELD

The present patent disclosure relates to video optimization, and specifically, relates to a voice bullet screen generation method and an electronic device.

### BACKGROUND

Currently, bullet screen input boxes occur during video viewing in a video website. A viewer enters characters in a bullet screen input box, which may be displayed in a video in real time, which makes viewers viewing the video to interact with each other and learns thoughts of other viewers viewing the video. However, in a process for implementing this disclosure, the inventor finds that in a relevant technology, a bullet screen form exists in a character form, which cannot satisfy a demand for diversification of viewers.

### SUMMARY

This disclosure provides a voice bullet screen generation method and an electronic device. The voice bullet screen generation method and the electronic device can make a user optionally listen to a bullet screen voice, providing more selections and better viewing experience to the user.

According to a first aspect, an embodiment of this disclosure provides a voice bullet screen generation method. The generation method includes: collecting a voice-form user comment or a character-form user comment; generating the character-form user comment according to the collected voice-form user comment or generating the voice-form user comment according to the collected character-form user comment; establishing a link between the character-form user comment and the voice-form user comment; and displaying the character-form user comment containing the link of the voice-form user comment to a user in a bullet screen form.

According to a second aspect, an embodiment of this disclosure provides a non-volatile computer storage medium, including computer executable instructions, where when being executed by at least one processor, the computer executable instructions causes the processor to execute the foregoing method.

According to a third aspect, an embodiment of this disclosure provides an electronic device, including: at least one processor; and a memory, where the memory stores a program executable by the at least one processor, and execution of the program by at least one processor causes the at least one processor to execute any foregoing voice bullet screen generation method of this disclosure.

In the voice bullet screen generation method and the electronic device that are provided in the embodiments of the present invention, first, a user comment may be collected, and the user comment may be in a character form or a voice form; if a voice-form user comment is collected, generating a character-form user comment according to the voice-form user comment; and if a character-form user comment is collected, generating a voice-form user comment according to the character-form user comment. Subsequently, a link is established between the voice-form user comment and the corresponding character-form user comment. Finally, after the link is established, the character-form user comment containing the link of the voice-form user comment is displayed to a user in a bullet screen form. The voice bullet screen generation method and the electronic device that are provided in the embodiments of this disclosure can make a user optionally listen to a bullet screen voice, providing more selections and better viewing experience to the user.

### BRIEF DESCRIPTION OF THE DRAWINGS

One or more embodiments are exemplarily described by using figures that are corresponding thereto in the accompanying drawings; the exemplary descriptions do not form a limitation to the embodiments. Elements with same reference signs in the accompanying drawings are similar elements. Unless otherwise particularly stated, the figures in the accompanying drawings do not form a scale limitation.

FIG. 1 is a flowchart of a voice bullet screen generation method according to an embodiment of this disclosure;

FIG. 2 is a schematic structural diagram of a voice bullet screen generation apparatus according to an embodiment of the present invention; and

FIG. 3 is a schematic structural diagram of an electronic device according to an embodiment of this disclosure.

### DESCRIPTION FOR REFERENCE SIGNS

1 collection module 2 processing module

### DETAILED DESCRIPTION

Specific implementation manners of the embodiments of this disclosure are described in detail with reference to the drawings below. It should be understood that specific implementation manners described herein are only used to describe and explain this disclosure but are not used to limit this disclosure.

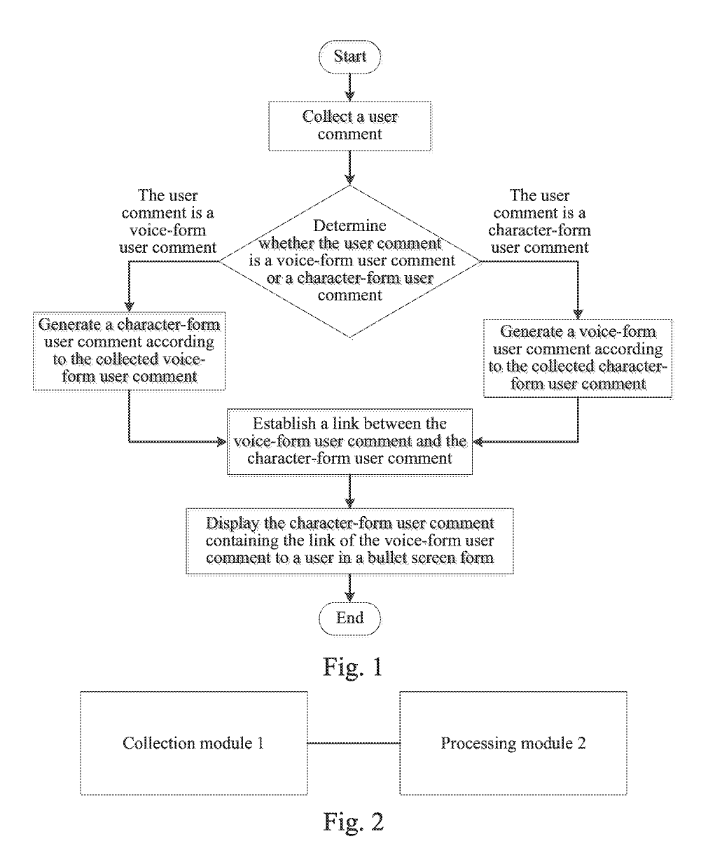

FIG. 1 is a flowchart of a voice bullet screen generation method according to an embodiment of this disclosure. As shown in FIG. 1, FIG. 1 is a voice bullet screen generation method. The generation method includes: collecting a voice-form user comment or a character-form user comment; generating the character-form user comment according to the collected voice-form user comment or generating the voice-form user comment according to the collected character-form user comment; establishing a link between the character-form user comment and the voice-form user comment; and displaying the character-form user comment containing the link of the voice-form user comment to a user in a bullet screen form.

First a user comment is collected, and the user comment may be in a character form or a voice form; whether the user comment is a voice-form user comment or a character-form user comment is determined; the character-form user comment can still be entered by using an existing text input box; as regards the voice-form user comment, an opportunity of using any voice input device for commenting in a voice form may be provided to a user in this embodiment of the present invention. If the voice-form user comment is collected, the character-form user comment is generated according to the voice-form user comment; if the character-form user comment is collected, the voice-form user comment is generated according to the character-form user comment. For example, a machine voice may be used to dub the user comment to generate the voice-form user comment.

Subsequently, a link is established between the voice-form user comment and the corresponding character-form user comment, so that the user can call a corresponding voice-form character comment by clicking on the character-form user comment. Finally, after the link is established, the character-form user comment containing the link of the voice-form user comment is displayed to a user in a bullet screen form. The user sees a character-form bullet screen and can listen to a voice-form bullet screen by clicking on the character-form bullet screen.

In addition, converting the user comment into the bullet screen in real time and displaying same to the user is only stated above. However, because some videos are outmoded or because of difference in viewing time, bullet screens are very little or even none if only converting the user comment into the bullet screen in real time is used. Therefore, for the problem, the generation method further includes: recording a period during which the voice-form user comment or the character-form user comment is collected in video playing; and when the video is played again, displaying the character-form user comment containing the link of the voice-form user comment to the user in a bullet screen form during the period.

A user comment is collected during each video playing. Each time a user comment is collected, a period of the user comment is recorded. The period may be duration, for example, 5 seconds. When the video is played again, a real-time bullet screen is displayed, and a user comment of which a period is recorded previously is displayed to the user in a bullet screen form when the video reaches a corresponding period. In this way, the user comment is made to be closely related to the video content, and the user is made to have the feeling of viewing the video with many people whenever whichever video the user views.

However, when character-form user comments containing the link of the voice-form user comment during the same period are increasingly many, a next period may be entered before all the character-form user comments containing the link of the voice-form user comment during the period are displayed. Therefore, in this case, not all character-form user comments containing the link of the voice-form user comment can be displayed to the user in a bullet screen form. In this embodiment of the present invention, in a case in which a quantity of the character-form user comments containing the link of the voice-form user comment and corresponding to the period is greater than a first threshold, randomly selecting a character-form user comment containing the link of the voice-form user comment from the character-form user comments containing the link of the voice-form user comment to be displayed to the user in a bullet screen form. Until a next period is entered, the character-form user comments containing the link of the voice-form user comment during this period stop displaying randomly, so as to randomly displaying character-form user comments containing the link of the voice-form user comment during next period. The first threshold may be freely set and is relevant to the setting length of the period and a moving speed of the bullet screen on the screen.

Considering limitation of storage space, because videos exist longer, user comments become more, and a situation in which storage space is insufficient or a speed of randomly selecting the character-form user comment containing the link of the voice-form user comment is excessively low may occur. Therefore, in this embodiment of this disclosure, in a case in which a quantity of the character-form user comments containing the link of the voice-form user comment and corresponding to the period is greater than a second threshold, each time a new character-form user comment containing the link of the voice-form user comment is generated, a character-form user comment containing the link of the voice-form user comment that is previously earliest generated is correspondingly deleted. The second threshold may be freely set and is relevant to storage space and the like, but should be much greater than the first threshold in some embodiments.

FIG. 2 is a schematic structural diagram of a voice bullet screen generation apparatus according to an embodiment of this disclosure. As shown in FIG. 2, FIG. 2 is a voice bullet screen generation apparatus. The generation apparatus includes: a collection module 1, configured to collect a voice-form user comment or a character-form user comment; and a processing module 2, configured to execute the following operations: generating the character-form user comment according to the voice-form user comment collected by the collection module or generating the voice-form user comment according to the collected character-form user comment; establishing a link between the character-form user comment and the voice-form user comment; and displaying the character-form user comment containing the link of the voice-form user comment to a user in a bullet screen form.

First, the collection module 1 collects a user comment and sends the user comment to a processing module 2, and the processing module 2 receives the user comment. The user comment may be in a character form or in a voice form. If the voice-form user comment is collected, the processing module 2 generates the character-form user comment according to the voice-form user comment; if the character-form user comment is collected, the processing module 2 generates the voice-form user comment according to the character-form user comment. For example, a machine voice may be used to dub the user comment to generate the voice-form user comment.

Subsequently, the processing module 2 establishes a link between the voice-form user comment and the corresponding character-form user comment, so that the user can call a corresponding voice-form character comment by clicking on the character-form user comment. Finally, after the link is established, the processing module 2 displays the character-form user comment containing the link of the voice-form user comment to a user in a bullet screen form.

The processing module 2 is further configured to: record a period during which the voice-form user comment or the character-form user comment is collected in video playing; and when the video is played again, display the character-form user comment containing the link of the voice-form user comment to the user in a bullet screen form during the period.

However, when character-form user comments containing the link of the voice-form user comment at the same period that are stored in the processing module 2 are increasingly many, a next period may be entered before all the character-form user comments containing the link of the voice-form user comment during the period are displayed. Therefore, in this embodiment of the present invention, the processing module 2 is further configured to: in a case in which a quantity of the character-form user comments containing the link of the voice-form user comment and corresponding to the period is greater than a first threshold, randomly select a character-form user comment containing the link of the voice-form user comment from the character-form user comments containing the link of the voice-form user comment to be displayed to the user in a bullet screen form. Until a next period is entered, the character-form user comments containing the link of the voice-form user comment during this period stop displaying randomly, so as to randomly displaying character-form user comments containing the link of the voice-form user comment during next period. The first threshold may be freely set and is relevant to the setting length of the period and a moving speed of the bullet screen on the screen.

Considering limitation of storage space of the processing module 2, because videos exist longer, user comments become more, and a situation in which storage space of the processing module 2 is insufficient or a speed of randomly selecting the character-form user comment containing the link of the voice-form user comment is excessively low may occur. Therefore, in this embodiment of the present invention, the processing module 2 is further configured to: in a case in which a quantity of the character-form user comments containing the link of the voice-form user comment and corresponding to the period is greater than a second threshold, each time a new character-form user comment containing the link of the voice-form user comment is generated, correspondingly delete a character-form user comment containing the link of the voice-form user comment that is previously earliest generated. The second threshold may be freely set and is relevant to storage space and the like, but should be much greater than the first threshold in some embodiments.

The technical solution of this embodiment of this disclosure is described in detail below by using specific application:

When a user views a video, the user may enter a character-form user comment by using an input box or may enter a voice-form user comment by using a voice collection apparatus. In this case, the collection module 1 collects the character-form user comment or the voice-form user comment, and sends the character-form user comment or the voice-form user comment to the processing module 2. The processing module 2 records a period at this moment. When the processing module 2 receives the character-form user comment, the processing module 2 generates the character-form user comment into the voice-form user comment and establishes a link between the character-form user comment and the generated voice-form user comment; when the processing module 2 receives the voice-form user comment, the processing module 2 generates the voice-form user comment into the character-form user comment and establishes a link between the voice-form user comment and the generated character-form user comment. The processing module 2 displays the processed character-form user comment containing the link of the voice-form user comment to the user. At the same time, the processing module 2 detects a quantity of the character-form user comment containing the link of the voice-form user comment and corresponding to the period that is recorded newly, and when the quantity is greater than a second threshold, deletes a character-form user comment containing the link of the voice-form user comment that is previously earliest generated. If the quantity is not greater than the second threshold, the processing module 2 detects whether a quantity of the character-form user comments containing the link of the voice-form user comment and corresponding to the period that is recorded newly is greater than the first threshold. When the quantity is greater than the first threshold, the processing module 2 randomly selects some character-form user comments containing the link of the voice-form user comment from the character-form user comments containing the link of the voice-form user comment and corresponding to the period that is recorded newly to be displayed to the user in a bullet screen form. When the quantity is not greater than the first threshold, the processing module 2 displays all character-form user comments containing the link of the voice-form user comment and corresponding to the period to the user in a bullet screen form. The user clicks on any one bullet screen (a character-form user comment) and plays the voice-form user comment of the bullet screen (a character-form user comment) link.

By means of the foregoing technical solution, in the voice bullet screen generation method and the voice bullet screen generation apparatus that are provided in the embodiments of this disclosure, first, a user comment may be collected, and the user comment may be in a character form or a voice form; if a voice-form user comment is collected, generating a character-form user comment according to the voice-form user comment; and if a character-form user comment is collected, generating a voice-form user comment according to the character-form user comment. Subsequently, a link is established between the voice-form user comment and the corresponding character-form user comment. Finally, after the link is established, the character-form user comment containing the link of the voice-form user comment is displayed to a user in a bullet screen form. The voice bullet screen generation method and the voice bullet screen generation apparatus that are provided in the embodiments of this disclosure can make a user optionally listen to a bullet screen voice, providing more selections and better viewing experience to the user.

This embodiment of this disclosure further provides a non-volatile computer storage medium, which stores computer executable instructions, where the computer executable instructions can execute the voice bullet screen generation method in any one of the foregoing method embodiments.

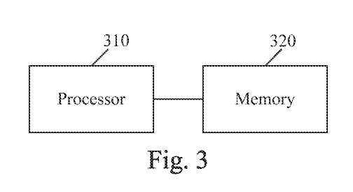

An embodiment of this disclosure further provides an electronic device. As shown in FIG. 3, the electronic device includes: a memory 310, a processor 320, and a bus system. The processor 320 is connected to the memory 310 by using the bus system, and the memory 310 is configured to store instructions. The processor 320 is configured to execute the instructions stored in the memory and is configured to execute an embodiment of the foregoing voice bullet screen generation method. For example, in an embodiment, that the processor is configured to a voice bullet screen generation method includes: collecting a voice-form user comment or a character-form user comment; generating the character-form user comment according to the collected voice-form user comment or generating the voice-form user comment according to the collected character-form user comment; establishing a link between the character-form user comment and the voice-form user comment; and displaying the character-form user comment containing the link of the voice-form user comment to a user in a bullet screen form.

The memory may be a non-volatile the computer readable storage medium, to store the computer executable instructions. When the instructions are executed by one or more processors, for example, the processor is made to execute steps of the foregoing method embodiment, such as steps described in FIG. 1, or the processor is made to execute functions of apparatus modules of the foregoing apparatus embodiment, such as functions of the collection module 1 to the processing module 2 described in FIG. 2. The computer executable instructions may also be stored and/or transmitted in any non-volatile the computer readable storage medium, so as to be used by instructions execution system, apparatus, or device or to be used by combining instructions execution system, apparatus, or device. The instructions execution system, apparatus, or device, is such as a computer-based system, a system including a processor, or another system that may acquire instructions from the instructions execution system, apparatus, or device and execute the instructions. For the objective of this document, “a non-volatile the computer readable storage medium” may be any medium physically containing or storing computer executable instructions, and the computer executable instructions may be used by the instructions execution system, device, or system or be used by combining the instructions execution system, apparatus, or device. The non-volatile the computer readable storage medium may include but is not limited to a magnetic, optical, and/or semiconductor storage apparatus. Examples of these storage apparatuses include a magnetic disk, an optical disc based on a CD, a DVD, or a blue-ray technology, and an everlasting solid-state memory (such as a flash memory and a solid-state driver).

It should be understood that in the embodiments of this disclosure, the processor may be a central processing unit, (Central Processing Unit, CPU for short). The processor may also be another general processor, a digital signal processing (DSP), an disclosure-specific integrated circuit (ASIC), a field programmable gate array (FPGA), or another programmable logic device, a discrete gate or transistor logic device, a discrete hardware component, or the like. The general processor may be a micro-processor or the processor may also be any conventional processor and the like.

In an implementation process, steps of the method or units of the apparatus may be completed by instructions in a form of an integrated logic circuit of hardware in the processor or software. The steps of the method or units of the apparatus that are disclosed in the embodiments of this disclosure may be directly embodied as being executed and completed by a hardware processor or being executed and completed by a hardware and software module in the processor. The software module may be located in a mature storage medium in the art, such as a random access memory, a flash memory, a read-only memory, a programmable read-only memory, or an electric erasable programmable memory and register. The storage medium is located in the memory, the processor reads information in the memory, and hardware thereof is combined to complete steps of the method. To avoid repetition, detailed description is not provided again herein.

The foregoing product can execute the method provided in the embodiments of this disclosure, and has corresponding functional modules for executing the method and beneficial effects. Refer to the method provided in the embodiments of this disclosure for technical details that are not described in detail in this embodiment.

The electronic device in this embodiment of this disclosure exists in multiple forms, including but not limited to:

(1) Mobile communication device: such devices are characterized by having a mobile communication function, and primarily providing voice and data communications;

terminals of this type include: a smart phone (for example, an iPhone), a multimedia mobile phone, a feature phone, a low-end mobile phone, and the like;

(2) Ultra mobile personal computer device: such devices are essentially personal computers, which have computing and processing functions, and generally have the function of mobile Internet access; terminals of this type include: PDA, MID and UMPC devices, and the like, for example, an iPad;

(3) Portable entertainment device: such devices can display and play multimedia content; devices of this type include: an audio and video player (for example, an iPod), a handheld game console, an e-book, an intelligent toy and a portable vehicle-mounted navigation device;

(4) Server: a device that provides a computing service; a server includes a processor, a hard disk, a memory, a system bus, and the like; an architecture of a server is similar to a universal computer architecture. However, because a server needs to provide highly reliable services, requirements for the server are high in aspects of the processing capability, stability, reliability, security, extensibility, and manageability; and

(5) Other electronic apparatuses having a data interaction function.

The apparatus embodiment described above is merely exemplary, and units described as separated components may be or may not be physically separated; components presented as units may be or may not be physical units, that is, the components may be located in a same place, or may be also distributed on multiple network units. Some or all modules therein may be selected according to an actual requirement to achieve the objective of the solution of this embodiment.

Through description of the foregoing implementation manners, a person skilled in the art can clearly learn that each implementation manner can be implemented by means of software in combination with a universal hardware platform, and certainly, can be also implemented by using hardware. Based on such understanding, the essence, or in other words, a part that makes contributions to relevant technologies, of the foregoing technical solutions can be embodied in the form of a software product. The computer software product may be stored in a computer readable storage medium, for example, a ROM/RAM, a magnetic disk, or a compact disc, including several instructions for enabling a computer device (which may be a personal computer, a sever, or a network device, and the like) to execute the method in the embodiments or in some parts of the embodiments.

Finally, it should be noted that: the foregoing embodiments are only used to describe the technical solutions of this disclosure, rather than limit this disclosure. Although this disclosure is described in detail with reference to the foregoing embodiments, a person of ordinary skill in the art should understand that he/she can still modify technical solutions disclosed in the foregoing embodiments, or make equivalent replacements to some technical features therein; however, the modifications or replacements do not make the essence of corresponding technical solutions depart from the spirit and scope of the technical solutions of the embodiments of this disclosure.

1. A voice bullet screen generation method, applied to a terminal, wherein the generation method comprises:
collecting a voice-form user comment or a character-form user comment;
generating the character-form user comment according to the collected voice-form user comment or generating the voice-form user comment according to the collected character-form user comment;
establishing a link between the character-form user comment and the voice-form user comment; and
displaying the character-form user comment containing the link of the voice-form user comment to a user in a bullet screen form.

2. The voice bullet screen generation method according to claim 1, wherein the generating the voice-form user comment according to the collected character-form user comment comprises:
when the collected user comment is in a character form, using a machine voice to dub the user comment to generate the voice-form user comment.

3. The voice bullet screen generation method according to claim 1, wherein the generation method further comprises:
recording a period during which the voice-form user comment or the character-form user comment is collected in video playing; and
when the video is played again, displaying the character-form user comment containing the link of the voice-form user comment and corresponding to the period to the user in a bullet screen form during the period, wherein the character-form user comment is previously collected during the period or is generated according to the voice-form user comment previously collected during the period.

4. The voice bullet screen generation method according to claim 3, wherein the generation method further comprises:
in a case in which a quantity of the character-form user comments containing the link of the voice-form user comment and corresponding to the period is greater than a first threshold, randomly selecting a character-form user comment containing the link of the voice-form user comment from the character-form user comments containing the link of the voice-form user comment to be displayed to the user in a in a bullet screen form.

5. The voice bullet screen generation method according to claim 3, wherein the generation method further comprises:
in a case in which a quantity of the character-form user comments containing the link of the voice-form user comment and corresponding to the period is greater than a second threshold, each time a new character-form user comment containing the link of the voice-form user comment is generated, correspondingly deleting a character-form user comment containing the link of the voice-form user comment that is previously earliest generated.

6-10. (canceled)

11. A non-volatile computer storage medium, which stores computer executable instructions that, when executed by an electronic device, cause the electronic device to:
collect a voice-form user comment or a character-form user comment;
generate the character-form user comment according to the collected voice-form user comment or generate the voice-form user comment according to the collected character-form user comment;
establish a link between the character-form user comment and the voice-form user comment; and
display the character-form user comment containing the link of the voice-form user comment to a user in a bullet screen form.

12. The non-volatile computer storage medium according to claim 11, wherein
the generate the voice-form user comment according to the collected character-form user comment comprises:
when the collected user comment is in a character form, using a machine voice to dub the user comment to generate the voice-form user comment.

13. The non-volatile computer storage medium according to claim 11, wherein
the electronic device is further caused to:
record a period during which the voice-form user comment or the character-form user comment is collected in video playing; and
when the video is played again, display the character-form user comment containing the link of the voice-form user comment and corresponding to the period to the user in a bullet screen form during the period, wherein the character-form user comment is previously collected during the period or is generated according to the voice-form user comment previously collected during the period.

14. The non-volatile computer storage medium according to claim 13, wherein the electronic device is further caused to:
in a case in which a quantity of the character-form user comments containing the link of the voice-form user comment and corresponding to the period is greater than a first threshold, randomly select a character-form user comment containing the link of the voice-form user comment from the character-form user comments containing the link of the voice-form user comment to be displayed to the user in a bullet screen form.

15. The non-volatile computer storage medium according to claim 13, wherein the electronic device is further caused to:
in a case in which a quantity of the character-form user comments containing the link of the voice-form user comment and corresponding to the period is greater than a second threshold, each time a new character-form user comment containing the link of the voice-form user comment is generated, correspondingly deleting a character-form user comment containing the link of the voice-form user comment that is previously earliest generated.

16. An electronic device, comprising:
at least one processor; and
a memory communicably connected with the at least one processor, wherein
the memory stores instructions executable by the at least one processor, wherein execution of the instructions by the at least one processor causes the at least one processor to:
collect a voice-form user comment or a character-form user comment;
generate the character-form user comment according to the collected voice-form user comment or generate the voice-form user comment according to the collected character-form user comment;
establish a link between the character-form user comment and the voice-form user comment; and
display the character-form user comment containing the link of the voice-form user comment to a user in a bullet screen form.

17. The electronic device according to claim 16, wherein the execution of the instructions to generate the voice-form user comment according to the collected character-form user comment cause the at least one processor to:
when the collected user comment is in a character form, use a machine voice to dub the user comment to generate the voice-form user comment.

18. The electronic device according to claim 16, wherein the at least one processor is further caused to:
record a period during which the voice-form user comment or the character-form user comment is collected in video playing; and
when the video is played again, display the character-form user comment containing the link of the voice-form user comment and corresponding to the period to the user in a bullet screen form during the period, wherein the character-form user comment is previously collected during the period or is generated according to the voice-form user comment previously collected during the period.

19. The electronic device according to claim 18, wherein the at least one processor is further caused to:
in a case in which a quantity of the character-form user comments containing the link of the voice-form user comment and corresponding to the period is greater than a first threshold, randomly select a character-form user comment containing the link of the voice-form user comment from the character-form user comments containing the link of the voice-form user comment to be displayed to the user in a bullet screen form.

20. The electronic device according to claim 18, wherein the at least one processor is further caused to:
in a case in which a quantity of the character-form user comments containing the link of the voice-form user comment and corresponding to the period is greater than a second threshold, each time a new character-form user comment containing the link of the voice-form user comment is generated, correspondingly delete a character-form user comment containing the link of the voice-form user comment that is previously earliest generated.
